(19) United States
(12) Patent Application Publication
(10) Pub. No.: US 2023/0127725 A1
(43) Pub. Date: Apr. 27, 2023

(54) SYSTEMS AND METHODS FOR USING EMPLOYEE PUBLIC DATA TO IDENTIFY AND CONFIDENCE SCORE RECRUITMENT OPPORTUNITIES

(71) Applicant: JPMORGAN CHASE BANK, N.A., New York, NY (US)

(72) Inventor: Shawn Wesley Alexander, Pearland, TX (US)

(21) Appl. No.: 18/046,056

(22) Filed: Oct. 12, 2022

Related U.S. Application Data
(60) Provisional application No. 63/270,179, filed on Oct. 21, 2021.

(51) Int. Cl. G06Q 10/10; G06Q 10/06

(52) U.S. Cl. CPC G06Q 10/1053; G06Q 10/063112

(57) ABSTRACT

A method for using employee public data to identify recruitment opportunities may include: identifying an internal employee network and an external employee network; identifying an external candidate from the internal and the external employee networks; mapping the external candidate to the internal and/or external employee networks; predicting, using a strength of a connection to the internal and/or external employee networks, a connection confidence score for the external candidate; identifying connections to a good or service offered by the organization for the external candidate; generating, using a trained machine learning engine, a recruitment confidence score for the external candidate based on the connection confidence score and the identified connections to the good or service offered by the organization; generating and sending a targeted recruitment communication to the external candidate; monitoring an employment status of the external candidate; and training the trained machine learning engine with the employment status.

### RELATED APPLICATIONS

This application claims priority to, and the benefit of, U.S. Provisional Patent Application Ser. No. 63/270,179, filed Oct. 21, 2021, the disclosure of which is hereby incorporated, by reference, in its entirety.

### BACKGROUND OF THE INVENTION

### 1. Field of the Invention

Embodiments generally relate to systems and methods for using employee public data to identify and confidence score recruitment opportunities.

### 2. Description of the Related Art

Identifying and recruiting new employees is an important part of any organization. Finding employees with values and goals that are in-line with an organization is critical to finding a long-term employee. Often, organizations use recruiters that focus on the potential employee's skills, while knowing little, if anything, about how the potential employee views the organization, the potential employee's connections with the organization, or how the potential employee will fit into the culture of the organization. This may lead to employees who do not last long at the organization.

### SUMMARY OF THE INVENTION

Systems and methods for using employee public data to identify and confidence score recruitment opportunities are disclosed. In one embodiment, a method for using employee public data to identify and confidence score recruitment opportunities may include: (1) identifying, by a computer program executed by an electronic device, an internal employee network from internal employee data from an internal data source for an organization; (2) identifying, by the computer program, an external employee network from external employee data from an external data source to the organization; (3) identifying, by the computer program, an external candidate from the internal employee network and the external employee network; (4) mapping, by the computer program, the external candidate to the internal employee network and/or the external employee network; (5) predicting, by the computer program and using a strength of a connection to the organization from the mapping to the internal employee network and/or the external employee network, a connection confidence score for the external candidate; (6) identifying, by the computer program, connections to a good or service offered by the organization for the external candidate; (7) generating, by the computer program and using a trained machine learning engine, a recruitment confidence score for the external candidate based on the connection confidence score and the identified connections to the good or service offered by the organization; (8) generating, by the computer program, a targeted recruitment communication to the external candidate; (9) communicating, by the computer program, the targeted recruitment communication to an electronic device associated with the external candidate; (10) monitoring, by the computer program, an employment status of the external candidate; and (11) training, by the computer program, the trained machine learning engine with the employment status.

In one embodiment, the method may also include calculating, by the computer program, a strength of the internal employee network; and calculating, by the computer program, a strength of the external employee network. The connection confidence score may also be based on the strength of the internal employee network and the external employee network.

In one embodiment, the strength of the internal employee network may be based on common features of employment.

In one embodiment, the common features of employment may include a common team, a common project, and/or common meetings.

In one embodiment, the strength of the external employee network may be based on common features outside of employment.

In one embodiment, the common features outside of employment may include social media connections, common social organization memberships, common schools attended, common family schools or events, and/or common communities.

In one embodiment, the connections to the good or service offered by the organization for the external candidate may include social media commentary by the external candidate on the good or service and/or use of the good or service offered by the organization.

In one embodiment, the trained machine learning engine may be trained using supervised training with historical recruiting data.

In one embodiment, the trained machine learning engine may be a neural network.

In one embodiment, the employment status of the external candidate may include offered employment, not offered employment, accepted employment, or rejected employment.

According to another embodiment, a non-transitory computer readable storage medium, including instructions stored thereon, which when read and executed by one or more computer processors, cause the one or more computer processors to perform steps comprising: identifying an internal employee network from internal employee data from an internal data source for an organization; identifying an external employee network from external employee data from an external data source to the organization; identifying an external candidate from the internal employee network and the external employee network; mapping the external candidate to the internal employee network and/or the external employee network; predicting, using a strength of a connection to the organization from the mapping to the internal employee network and/or the external employee network, a connection confidence score for the external candidate; identifying connections to a good or service offered by the organization for the external candidate; generating, using a trained machine learning engine, a recruitment confidence score for the external candidate based on the connection confidence score and the identified connections to the good or service offered by the organization; generating a targeted recruitment communication to the external candidate; communicating the targeted recruitment communication to an electronic device associated with the external candidate; monitoring an employment status of the external candidate; and training the trained machine learning engine with the employment status.

In one embodiment, the non-transitory computer readable storage medium of claim 11, may also include instructions stored thereon, which when read and executed by one or more computer processors, cause the one or more computer processors to perform steps including: calculating a strength of the internal employee network; and calculating a strength of the external employee network. The connection confidence score may also be based on the strength of the internal employee network and the external employee network.

In one embodiment, the strength of the internal employee network may be based on common features of employment.

In one embodiment, the common features of employment may include a common team, a common project, and/or common meetings.

In one embodiment, the strength of the external employee network may be based on common features outside of employment.

In one embodiment, the common features outside of employment may include social media connections, common social organization memberships, common schools attended, common family schools or events, and/or common communities.

In one embodiment, the connections to the good or service offered by the organization for the external candidate may include social media commentary by the external candidate on the good or service and/or use of the good or service offered by the organization.

In one embodiment, the trained machine learning engine may be trained using supervised training with historical recruiting data.

In one embodiment, the trained machine learning engine may be a neural network.

In one embodiment, the employment status of the external candidate may include offered employment, not offered employment, accepted employment, or rejected employment.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for using employee public data to identify and confidence score recruitment opportunities according to an embodiment;

FIG. 2 depicts a method for using employee public data to identify and confidence score recruitment opportunities according to an embodiment;

FIG. 3 depicts an exemplary computing system for implementing aspects of the present disclosure.

### DETAILED DESCRIPTION OF PREFERRED EMBODIMENTS

Systems and methods for using employee public data to identify and confidence score recruitment opportunities are disclosed.

Embodiments may create an internal network map of current employees of an organization based on location, job type, job function, and skills. Machine learning may be used to then map social media and other public accounts for those employees. This creates a map of external candidates that have connections with current employees. By examining their social media and public accounts for the external candidates, embodiments may identify their skills, previous employment history, connections with other current employees, etc. A machine learning algorithm may increase the connection confidence score (e.g., a likelihood of a positive connection) based on the number of and strength of connections to current employees.

Embodiments may further identify external candidates with a positive perception of the organization based on their connections with current employees, use of the organization's products or services, etc.

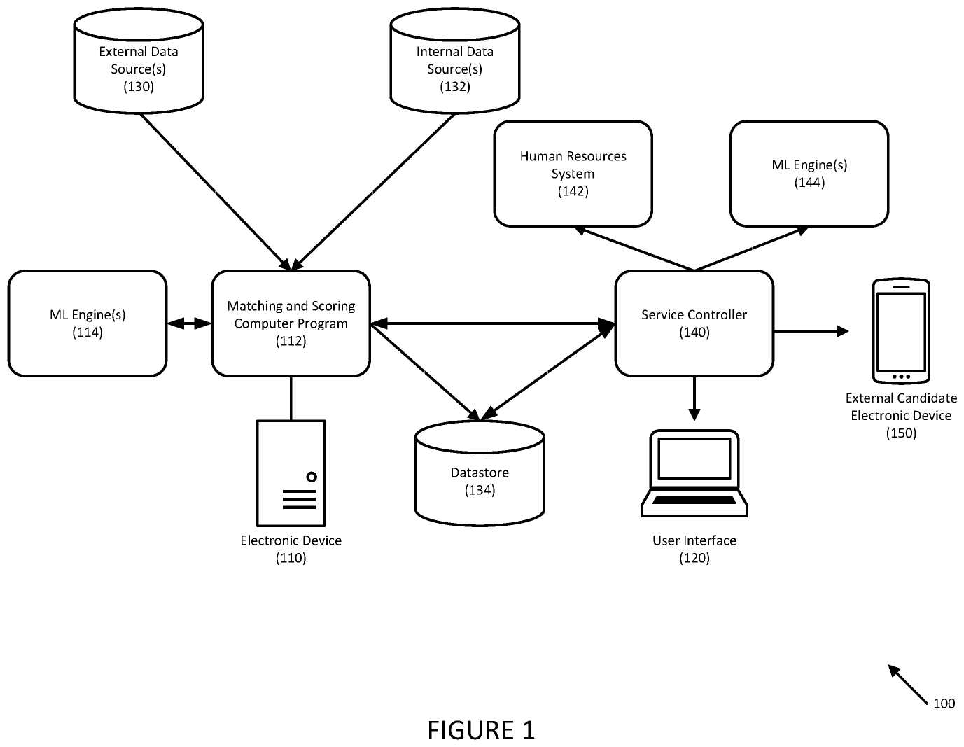

FIG. 1 discloses a system for using employee public data to identify and confidence score recruitment opportunities according to an embodiment. System 100 may include electronic device 110, which may be a server (e.g., physical and/or cloud-based), a computer (e.g., workstation, desktop, laptop, notebook, tablet, smart device, etc.), etc. Electronic device 110 may execute matching and scoring computer program 112.

Matching and scoring computer program 112 may interface with one or more external data sources 130, such as social media sites and other data sources, and one or more internal data sources 132 such as human resources data, company directories, etc. Matching and scoring computer program 112 may ingest data from external data sources 130 and internal data sources 132 and may build network maps that connect external candidates to internal employees. Matching and scoring computer program 112 may ingest data from internal data sources 132 and may ingest data through existing communication channels (e.g., messaging, email, code, organizations, clubs, and interests).

Matching and scoring program 112 may review the strength and depth of any connections between the external candidates and the internal employees using one or more machine learning engines 114. For example, machine learning engines 114 may be trained with historical data and may predict a strength of a connection between the external candidate and one or more employee, the likelihood of the external candidate applying for a job in the organization, a likelihood of the candidate being a successful employee at the organization (e.g., employed for at least a period of time) for the external candidate, a likelihood of a cultural fit for the external candidate within the organization, a likelihood that the organization will make an employment offer to the external candidate, a likelihood that the external candidate will accept an employment offer from the organization, etc. Other predictions may be made as is necessary and/or desired.

Datastore 134 may store matched and scored connections between the external candidates and internal employees. It may also include employee lists, employee and external candidate social media links, employee and external candidate network graphs, statistical analysis from prior recruiting candidates, scoring explanations for external recruiting leads, etc.

Service controller 140 may be a computer program that may control the workflow of extracting information from datastore 134, enriching it with information from human resources system 142 to update the recruitment workflow, generate and send messages to external candidates, and provide workflow statuses. For example, service controller 140 may receive requests for external candidate predictions and may retrieve information from datastore 134. It may then query human resources system 142 for additional data to enrich the information retrieved from datastore 134. This may include, for example, external recruit prior recruitment efforts with the external candidate, internal employee sentiment data, internal employee performance data, external candidate contact information, etc.

In one embodiment, service controller 140 may be a computer program that may be part of matching and scoring computer program 112.

User interface 120 may provide an interface to features such as management, administration, search, recruiter interaction portal, etc. to an internal user, such as a human resources employee. For example, human resources employees may submit queries to service controller 140, which may then query datastore 134 for external candidate information and may then enrich the external candidate information with information from human resources system 142. Service controller may then initiate contact with an external candidate using, for example, external candidate electronic device 150. Human resources system 142 may monitor the results of the contact and may use the results to train matching and scoring computer program 112.

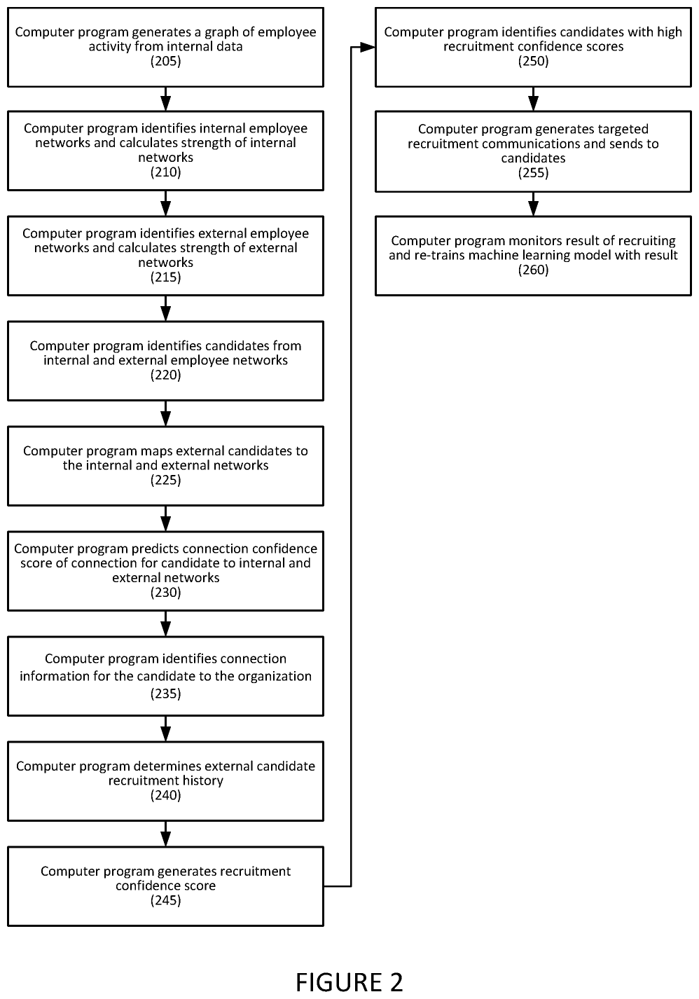

FIG. 2 discloses a method for using employee public data to identify and confidence score recruitment opportunities according to an embodiment.

In step 205, a computer program may retrieve data from internal organization networks for employees to generate a graph of employee activity. This may be based on employee connections, hierarchy, etc. In one embodiment, connections (e.g., edges) may be identified based on employee communications, common areas within a facility, common meetings attended, etc.

In step 210, the computer program may identify internal employee to employee networks, and may calculate a strength of each of the networks. The internal employee networks are based on common features of employment, such as common locations, common teams, common projects, etc. In one embodiment, a machine learning algorithm or neural network may be trained to predict the strength of each internal employee network based on historical data. For example, the strength of each internal employee network may be based on a number of connections in the graph (e.g., common areas, common meetings, common teams, etc.), etc. The machine learning algorithm or neural network may be trained to identify historical patterns for internal employee networks with similar depths and breadths (depth being the number of unique network connection points and breadth being the number of connection paths to the same network connection points).

In step 215, the computer program may identify external employee networks between employees and may calculate a strength of the external employee networks. The external employee networks may be based on common features outside of employment, such as social media connections, common social organization memberships, common meetings attended, common schools attended, common family schools or events, common communities, etc. A machine learning algorithm or neural network that may be trained on external networks may calculate a strength of the external networks on historical patterns for external networks with similar depths and breadths (depth being the number of unique network connection points and breadth being number of connection paths to the same network connection points) to determine the strength of the external network.

In step 215, the computer program may identify external candidates based on the internal and external employee networks. For example, the computer program may identify overlaps between the internal and external employee networks and may identify potential candidates in the external employee networks in this overlap. The computer program may identify common social media connections, common external blog communications, common memberships in external organizations, common interests, etc. that the external candidate may have with one or more of the internal or external networks.

In step 220, the computer program may map the identified external candidates to one or more of the internal or external networks and, in step 225, may map the external candidates to the internal and/or external employee networks. This may identify connections between the external candidate and the networks.

In step 230, the computer program may predict one or more connection confidence scores, such as the likelihood of successful recruitment, suitability of candidate to positions, likelihood of recruit being successful over a certain period (e.g., three years) in the organization based on the strength of connections. In one embodiment, another machine learning algorithm may use the strength of the internal and/or external employee networks, as well as the strength of the external candidate's connection (e.g., duration, proximity, frequency of interaction, etc.) to those networks, as well as historical data from prior external connection hiring attempts, to make these predictions. Other criteria may be used as is necessary and/or desired.

In another embodiment, the external candidates may be specifically identified, or the external candidates may be based on a location, a role, etc.

In step 235, the computer program may identify connections that the external candidate may have with the organization, such as any goods or services provided by the organization that the external candidate may use, perceptions of the organization that the external candidate may have (e.g., based on social media “likes,” commentary, etc.). For example, if the organization provides a product, the computer program may identify whether the external candidate uses the product, has a favorable or unfavorable view of the product (e.g., from social media), etc. As another example, if the organization provides a financial product (e.g., mortgage, credit cards, checking or savings accounts, etc.), the computer program may determine if the external candidate is a customer of the organization, uses the products, etc.

In step 240, the computer program may whether the external candidate has applied for or had been previously recruited for a position within the organization. For example, the computer program may determine may review internal communications, HR databases, etc. to make this determination. This determination may impact a likelihood of recruiting success, as a previously recruited candidate that did not accept a position may be less likely to accept a position. The review may also identify any reasons to not proceed further with the recruiting process.

In step 245, a computer program may generate a recruitment confidence score for the external candidates based on available roles, the connection confidence score, the identified connections that the external candidate may have with the organization, the perception of the organization, etc. For example, the recruitment confidence score may be a combination of the internal connection sentiment, performance, history, and compensation band data, etc. Embodiments may seek to identify external candidate based on their likely perception of the organization (based on the strength and depth of connections to internal employees, use of goods or services offered by the organization, etc.) and fit for roles (location, skills, experience).

In embodiments, machine learning models may be used to create the recruitment confidence score predicting successful recruitment. The recruitment confidence score model may be based on a number of attributes including, for example, a number of connections the external candidate has with internal employees, the depth of the connections (e.g., length of time they have been connected, prior work experience, prior training or conference attendance, prior group membership), a confidence of positive communication about the organization (e.g., based on employee performance rating, feedback, career development, etc.), etc. Machine learning models may learn, over time and based on these attributes and recruitment results, the characteristics for candidates that are likely to be good fits for the organization, likely to have a positive opinion of the organization, and are likely to result in a successful recruitment.

In embodiments, retention information for the successful recruitments may be considered to predict a likelihood of retaining recruits.

In step 250, the computer program may identify external candidates that have a high recruitment confidence scores and may provide the identities of such candidates to internal and/or external recruiter systems.

In step 255, the computer program may generate custom and targeted recruitment communications for the candidates, and those recruitment communications may be provided via normal communication channels (e.g., social media, email, text message, etc.). For example, a service controller may instruct a human resources system to generate a communication for the external candidate, and may then send the communication to the external candidate based on, for example, recruiter preferences.

In step 260, the computer program may monitor the results of the recruiting effort, and may re-train the machine learning model with the results. For example, the computer program may monitor any responses to the targeted communication to determine whether the candidate had interest. The computer program may also monitor whether the external candidate was offered a position, whether the external candidate accepted the position, etc. Once hired, the computer program may monitor the external candidate (now employee) performance (e.g., performance reviews, promotions, etc.) as well as the length of time that the employee is employed.

Embodiments may reduce the time to fill open positions because candidates with a positive perception of the organization with the requisite skills may be identified. Embodiments may lead to improved retention based on the perception and the strength of connection to current employees. And embodiments may provide an accurate fit by finding candidates that match the organization's culture and that have a realistic expectation of working at the organization.

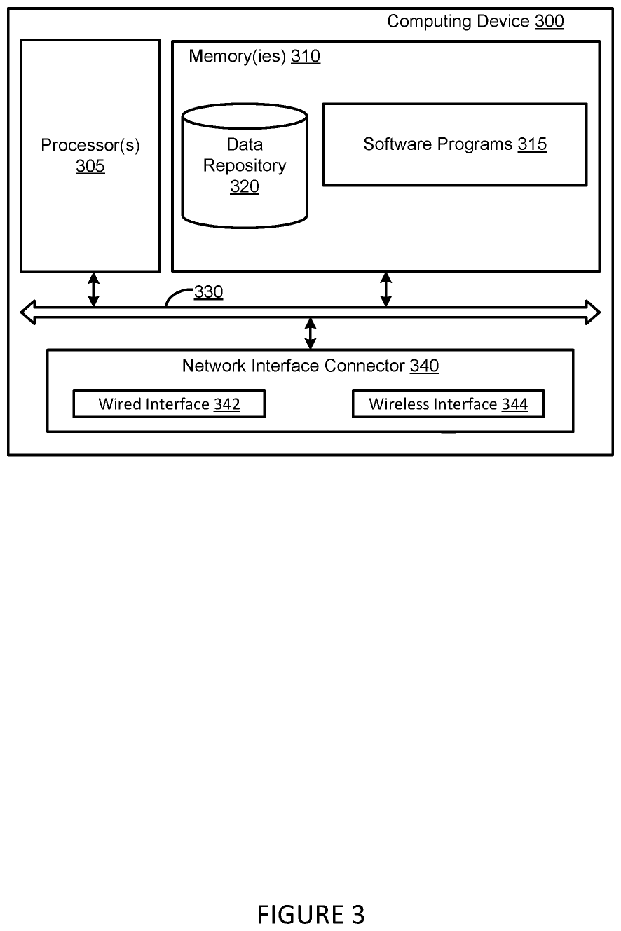

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for using employee public data to identify and confidence score recruitment opportunities, comprising:
identifying, by a computer program executed by an electronic device, an internal employee network from internal employee data from an internal data source for an organization;
identifying, by the computer program, an external employee network from external employee data from an external data source to the organization;
identifying, by the computer program, an external candidate from the internal employee network and the external employee network;
mapping, by the computer program, the external candidate to the internal employee network and/or the external employee network;
predicting, by the computer program and using a strength of a connection to the organization from the mapping to the internal employee network and/or the external employee network, a connection confidence score for the external candidate;
identifying, by the computer program, connections to a good or service offered by the organization for the external candidate;
generating, by the computer program and using a trained machine learning engine, a recruitment confidence score for the external candidate based on the connection confidence score and the identified connections to the good or service offered by the organization;
generating, by the computer program, a targeted recruitment communication to the external candidate;
communicating, by the computer program, the targeted recruitment communication to an electronic device associated with the external candidate;
monitoring, by the computer program, an employment status of the external candidate; and
training, by the computer program, the trained machine learning engine with the employment status.

2. The method of claim 1, further comprising:
calculating, by the computer program, a strength of the internal employee network; and
calculating, by the computer program, a strength of the external employee network;
wherein the connection confidence score is further based on the strength of the internal employee network and the external employee network.

3. The method of claim 2, wherein the strength of the internal employee network is based on common features of employment.

4. The method of claim 3, wherein the common features of employment comprise a common team, a common project, and/or common meetings.

5. The method of claim 2, wherein the strength of the external employee network is based on common features outside of employment.

6. The method of claim 5, wherein the common features outside of employment comprise social media connections, common social organization memberships, common schools attended, common family schools or events, and/or common communities.

7. The method of claim 1, wherein the connections to the good or service offered by the organization for the external candidate comprise social media commentary by the external candidate on the good or service and/or use of the good or service offered by the organization.

8. The method of claim 1, wherein the trained machine learning engine is trained using supervised training with historical recruiting data.

9. The method of claim 1, wherein the trained machine learning engine comprises a neural network.

10. The method of claim 1, wherein the employment status of the external candidate comprises offered employment, not offered employment, accepted employment, or rejected employment.

11. A non-transitory computer readable storage medium, including instructions stored thereon, which when read and executed by one or more computer processors, cause the one or more computer processors to perform steps comprising:
identifying an internal employee network from internal employee data from an internal data source for an organization;
identifying an external employee network from external employee data from an external data source to the organization;
identifying an external candidate from the internal employee network and the external employee network;
mapping the external candidate to the internal employee network and/or the external employee network;
predicting, using a strength of a connection to the organization from the mapping to the internal employee network and/or the external employee network, a connection confidence score for the external candidate;
identifying connections to a good or service offered by the organization for the external candidate;
generating, using a trained machine learning engine, a recruitment confidence score for the external candidate based on the connection confidence score and the identified connections to the good or service offered by the organization;
generating a targeted recruitment communication to the external candidate;
communicating the targeted recruitment communication to an electronic device associated with the external candidate;
monitoring an employment status of the external candidate; and
training the trained machine learning engine with the employment status.

12. The non-transitory computer readable storage medium of claim 11, further including instructions stored thereon, which when read and executed by one or more computer processors, cause the one or more computer processors to perform steps comprising:
calculating a strength of the internal employee network; and
calculating a strength of the external employee network;
wherein the connection confidence score is further based on the strength of the internal employee network and the external employee network.

13. The non-transitory computer readable storage medium of claim 12, wherein the strength of the internal employee network is based on common features of employment.

14. The non-transitory computer readable storage medium of claim 13, wherein the common features of employment comprise a common team, a common project, and/or common meetings.

15. The non-transitory computer readable storage medium of claim 12, wherein the strength of the external employee network is based on common features outside of employment.

16. The non-transitory computer readable storage medium of claim 15, wherein the common features outside of employment comprise social media connections, common social organization memberships, common schools attended, common family schools or events, and/or common communities.

17. The non-transitory computer readable storage medium of claim 11, wherein the connections to the good or service offered by the organization for the external candidate comprise social media commentary by the external candidate on the good or service and/or use of the good or service offered by the organization.

18. The non-transitory computer readable storage medium of claim 11, wherein the trained machine learning engine is trained using supervised training with historical recruiting data.

19. The non-transitory computer readable storage medium of claim 11, wherein the trained machine learning engine comprises a neural network.

20. The non-transitory computer readable storage medium of claim 11, wherein the employment status of the external candidate comprises offered employment, not offered employment, accepted employment, or rejected employment.
